(19) United States
(12) Patent Application Publication
(10) Pub. No.: US 2006/0273538 A1
(43) Pub. Date: Dec. 7, 2006

(54) Wheel of a baby walker with a function of preventing the speed from getting too high

(76) Inventor: A-Chueh Chuang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/142,285

(22) Filed: Jun. 2, 2005

(51) Int. Cl. B62B 7/00

(52) U.S. Cl. 280/87.051

(57) ABSTRACT

A wheel includes a support member joined to a frame of a baby walker, and left and right turning part joined together, and supported on the support member; the support member has a stopping protrusion on an upper portion of a first side; the left turning part is positioned over the first side of the support member, and has a middle hole, and first and second confining rooms, which are on two sides of the middle hole, and which extend to the edge of the left turning part; a rolling bead is confined and displaceable in the first confining room of the left turning part; thus, if the baby walker is suddenly speeded up with a great force, the rolling bead will get into contact with the stopping protrusion owing to the great centrifugal force, and in turn rotation of the turning parts is slowed down.

### BACKGROUND OF THE INVENTION

1. Field of the Invention

The present invention relates to a wheel of a baby walker, more particularly one, which has a simple structure, and is easy to assemble.

2. Brief Description of the Prior Art

Referring to FIG. 6, a conventional wheel of a baby walker includes a support member 71, a right part 72, a left part 73, and a rolling bead 74, and a lateral cover 75.

The support member 71 has a connecting post 711 secured on the top, a round hole 714 on a middle portion, and two screw holes 713. The support member 11 is joined to a frame 712 of a baby walker at the connecting post 111. The right turning part 72 has spaced apart recesses 722 on a tire surface thereof, and a hollow cylindrical portion 721 on a middle portion. The left turning part 73 has a hollow cylindrical portion 731 on a middle portion, spaced apart recesses 734 on a tire surface thereof, a square stick portion 732 extending from one end of the hollow cylindrical portion 731, and a diametrally-extending confining room 735. The square stick portion 732 has a lengthways-extending screw hole 733. The lateral cover 75 has two screw holes 751, a round recess 753 on an inner side, and a stopping plate portion 754 in an upper half portion of the round recess 752 thereof.

In assembly, the right turning part 72 is positioned on one side of the support member 71 with the hollow cylindrical portion 721 being held in the round hole 714. The rolling bead 74 is positioned in the confining room 735 of the left turning part 73. The left turning part 73 is joined to the right turning part 72 with both the hollow cylindrical portion 731 and the square stick portion 732 thereof being fitted in the hollow cylindrical portion 721 of the right turning part 72; a threaded element 723 is joined to the right turning element 72, and passed into the screw hole 733 of the square stick portion 732. The lateral cover 75 is positioned next to the left turning part 73, and securely joined to the support member 71 by means of threaded elements 752, which are passed through the screw holes 751, and passed into the screw holes 713.

If the baby walker moves along at a normal speed, the rolling bead 74 won't get into contact with the stopping plate portion 754 of the lateral cover 75, and rotation of the turning parts 72 and 73 won't be hindered. If the baby walker is suddenly speeded up with a great force, the rolling bead 74 will get into contact with the stopping plate portion 754 owing to the great centrifugal force. Consequently, rotation of the turning parts 72 and 73 of the wheel will be restrained by the stopping plate portion 754 of the lateral cover 75, and the baby walker is slowed down to avoid danger.

However, the above wheel has disadvantages as followings:

1. When the left and the right turning parts revolve, the rolling bead will travel the whole distance of the diametrally-extending confining room, and hit the inner side of the circular portion of the left turning part at relatively high speed. Consequently, loud noises will be produced when a baby is using the baby walker.

2. Besides the support part, and the left and the right turning parts, the wheel is equipped with the lateral cover, which is secured in position by means of threaded elements. Therefore, the manufacturer has to prepare a mould for producing lateral covers with, and it takes more time and labor to manufacture and assemble the wheel.

### SUMMARY OF THE INVENTION

It is an object of the present invention to provide an improvement on a wheel of a baby walker, which is free of the above-mentioned drawbacks. The wheel includes a support member joined to a frame of a baby walker, and left and right turning part, which are joined together, and supported on the support member. The support member has a stopping protrusion on an upper portion of a first side thereof. The left turning part is positioned over the first side of the support member, and has a middle hole, and first and second confining rooms, which are on two sides of the middle hole, and which extend to the edge of the left turning part. A rolling bead is confined and displaceable in the first confining room of the left turning part. Thus, if the baby walker is suddenly speeded up with a great force, the rolling bead will get into contact with the stopping protrusion owing to the great centrifugal force, and in turn the baby walker is slowed down to avoid danger.

### BRIEF DESCRIPTION OF THE DRAWINGS

The present invention will be better understood by referring to the accompanying drawings, wherein:

FIG. 1 is an exploded perspective view of the wheel of a baby walker according to the present invention,

FIG. 2 is an exploded perspective view of the left turning part of the wheel of the present invention,

FIG. 3 is a perspective view of the wheel of the present invention,

FIG. 4 is a view of the present wheel rotating at a normal speed,

FIG. 5 is a view of the present wheel suddenly speeded up with a great force, and

FIG. 6 is an exploded perspective view of the conventional wheel.

### DETAILED DESCRIPTION OF THE PREFERRED EMBODIMENTS

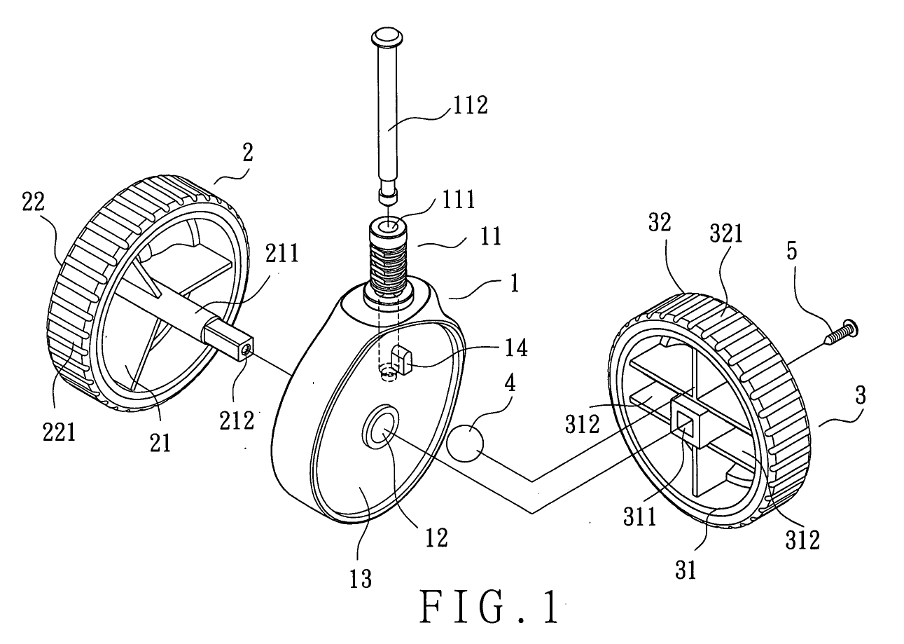

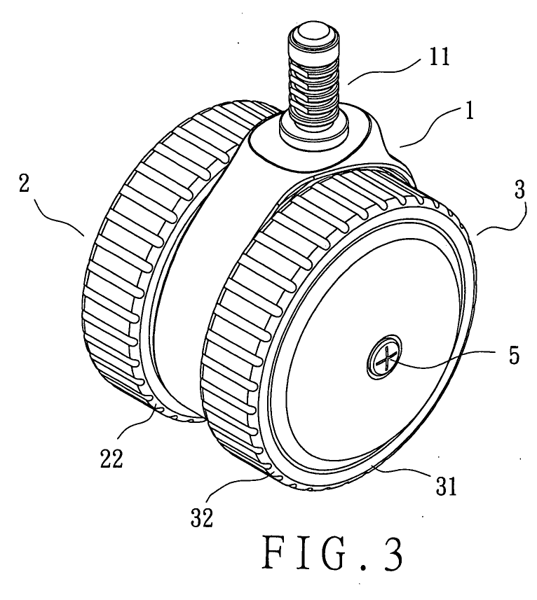

Referring to FIGS. 1, 2, and 3, a preferred embodiment of a wheel of a baby walker includes a support member 1, a right part 2, a left part 3, and a rolling bead 4.

The support member 1 has a connecting post 11 secured on the top, two round recesses 13 on left and right sides, a round hole 12 on a middle portion, and a stopping protrusion 14 on an upper portion of the left side. The connecting post 11 has an axial hole 111. The support member 1 is joined to a frame of a baby walker at the connecting post 11, and a fitting stick 112 is inserted in the axial hole 111 of the connecting post 11 and joined to the baby walker frame to strengthen the connection between the support member 11 and the frame.

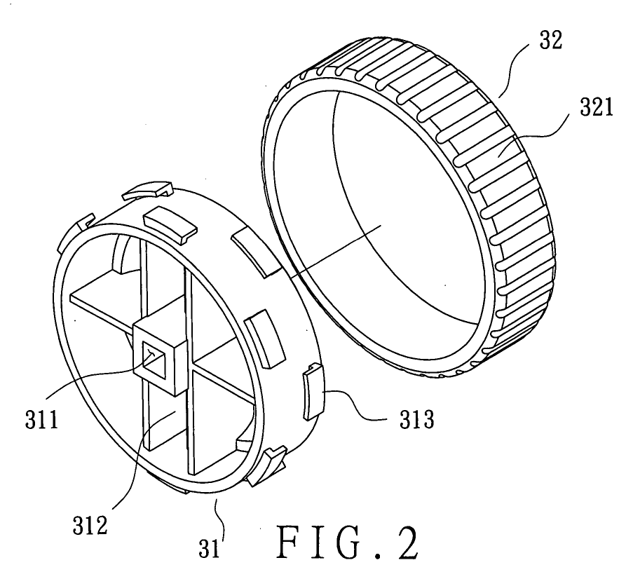

The left turning part 3 has a frame 31, and a tire 32 positioned over an outer side of the frame 31. The tire 32 is made of soft rubber, and has spaced apart recesses 321 thereon. The frame 31 has a square fitting hole 311 on a middle portion, and two confining rooms 312 on two sides of the square fitting hole 311, which extend to an edge of the frame 31. Furthermore, referring to FIG. 2, the frame 31 of the left turning part 3 has first and second groups of protruding portions 313, which are spaced apart near to left and right edges of the outer side respectively, and which are in the shape of an inverted “L”; the first group of protruding portions 313 are formed in such position as not to exactly face the second group. Thus, the tire 32 and the frame 31 will be firmly joined.

The right turning part 2 has a frame 21, and a tire 22 positioned over an outer side of the frame 21. The tire 22 is made of soft rubber, and has spaced apart recesses 221 thereon. The frame 21 has an axle 211 on a middle portion, and a square rod portion projecting from an inward end of the axle 211, which square rod portion has a lengthways-extending screw hole 212. Furthermore, the frame 21 is similar to the frame 31 of the left turning part 3, having first and second groups of protruding portions, which are spaced apart near to left and right edges of the outer side respectively, and which are in the shape of an inverted “L”; the first group of protruding portions are formed in such position as not to exactly face the second group. Thus, the tire 22 and the frame 21 will be firmly joined.

In assembly, the right turning part 2 is positioned on the right round recess 13 of the support member 1 with the axle 211 being passed through the round hole 12 of the support member 1. The rolling bead 312 is positioned in a first one of the confining rooms 312 of the left turning part 3. The left turning part 3 is positioned on the left round recess 13 of the support member 1 with the square rod portion of the right turning part 2 being fitted in the square fitting hole 311. And, a threaded element 5 is passed into the left turning part 3 and the screw hole 212 of the right turning part 2. Thus, the right and the left turning parts 2 and 3 can turn on the support member 1.

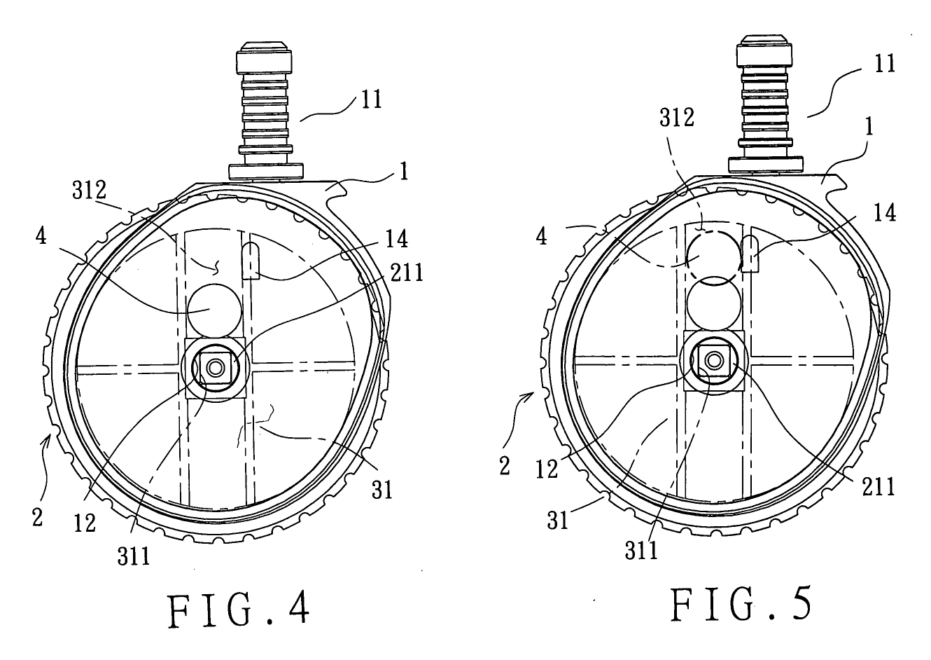

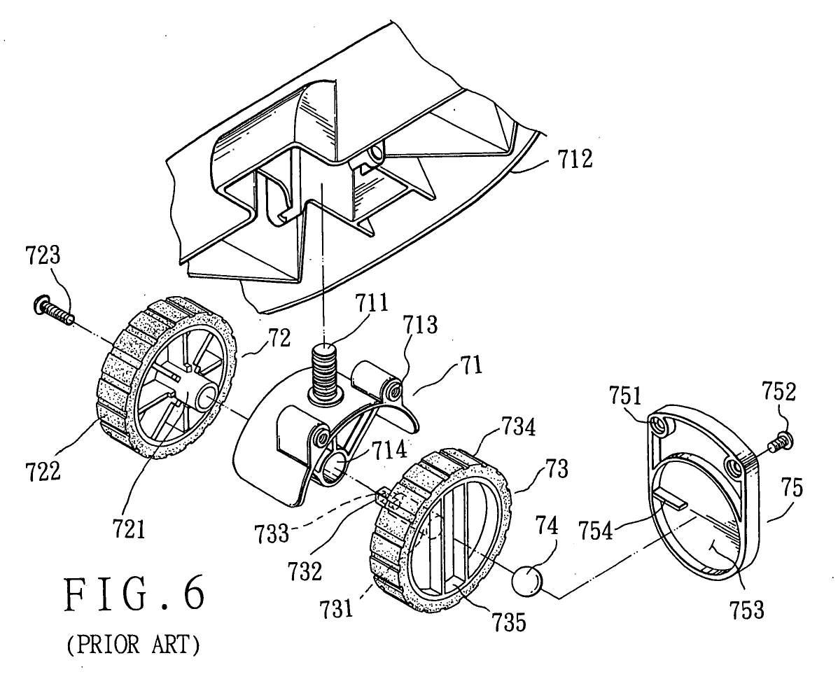

Referring to FIG. 4, if the baby walker moves along at a normal speed, the rolling bead 4 will be close to the middle square fitting hole 311 of the left turning part 3 when the first confining room 312 faces the upper half portion of the round recess 13 of the support member 1. Therefore, the rolling bead 4 won't get into contact with the stopping protrusion 14 formed on the upper portion of the left side of the support member 1, and rotation of the turning parts 2 and 3 of the wheel won't be hindered by the stopping protrusion 14. Consequently, the baby walker keeps on moving along in the normal way.

Referring to FIG. 5, if the baby walker is suddenly speeded up with a great force, the rolling bead 4 will stay apart from the middle square fitting hole 311, and close to the edge of the left turning part 3 owing to the great centrifugal force when the first confining room 312 faces the upper half portion of the round recess 13 of the support member 1. Thus, the rolling bead 4 will get into contact with the stopping protrusion 14, and in turn rotation of the turning parts 2 and 3 of the wheel will be subjected to restraint of the stopping protrusion 14. Consequently, the baby walker is slowed down to avoid danger.

From the above description, it can be easily understood that the present wheel of a baby walker has advantages as followings:

1. The length of the first confining room is smaller than one half of the diameter of the left turning part. Therefore, the rolling bead of the present invention will roll within a much shorter space than that of the conventional wheel, and there won't be loud noise produced when the present wheel rotates.

2. The wheel of the present invention doesn't have an additional lateral cover like the conventional wheel therefore the present wheel has a simpler structure, and lower manufacturing cost.

3. It takes fewer steps and less labor to assemble the wheel of the present invention than it does to assemble the conventional wheel as described in Background.

What is claimed is:

1. A wheel of a baby walker, comprising
a support member securely joined to a frame of a baby walker; the support member having a connecting post on a top, which is inserted in the frame of the baby walker; the support member having a round hole on a middle portion; the support member having a stopping protrusion on an upper portion of a first side thereof;
a right turning part arranged on other side of the support member; the right turning part having an axle portion passed through the round hole of the support member;
a left turning part arranged on the first side of the support member; the left turning part having a middle hole; the left turning part having first and second confining rooms on two sides of the middle hole and extending to an edge of the left turning part; the left turning part being positioned around the axle portion of the right turning part at the middle hole thereof; a threaded element being joined to the left turning part and engaged with the axle portion of the right turning part; and
a rolling bead confined and displaceable in the first confining room of the left turning part.

2. The wheel as claimed in claim 1, wherein the right turning part includes a frame, and a tire positioned over an outer side of the frame; the frame having first and second groups of protruding portions, which are spaced apart near to left and right edges of the outer side thereof respectively, and which are in a shape of an inverted “L”; the first group of protruding portions being formed in such position as not to exactly face the second group.

3. The wheel as claimed in claim 1, wherein the left turning part includes a frame, and a tire positioned over an outer side of the frame; the frame having first and second groups of protruding portions, which are spaced apart near to left and right edges of the outer side thereof respectively, and which are in a shape of an inverted “L”; the first group of protruding portions being formed in such position as not to exactly face the second group.
